(19) United States
(12) Patent Application Publication
(10) Pub. No.: US 2016/0293156 A1
(43) Pub. Date: Oct. 6, 2016

(54) IN-EAR HEADPHONES WITH NOISE REDUCTION EFFECT

(71) Applicant: CHARTER MEDIA (DONGGUAN) CO., LTD., Dongguan City (CN)

(72) Inventors: Shao-Cong YANG, Dongguan City (CN); Wai-Ming LO, Dongguan City (CN); On-Yung WONG, Dongguan City (CN)

(73) Assignee: Charter Media (Dongguan) CO. Ltd., Dongguan City (CN)

(21) Appl. No.: 15/038,387

(22) PCT Filed: Apr. 1, 2015
(86) PCT No.: PCT/CN2015/000228

§ 371 Date: May 20, 2016

(30) Foreign Application Priority Data
Oct. 30, 2014 (CN) 201410597710.7

(51) Int. Cl. G10K 11/178; H04R 3/00; H04R 1/10

(52) U.S. Cl. CPC G10K 11/1784; H04R 1/1016; H04R 1/1058; H04R 3/005; H04R 1/1083; H04R 2460/01

(57) ABSTRACT

In-ear headphones comprise a headphone shell, wherein a sound making unit and a control circuit are installed in the headphone shell, a first cavity, a second cavity and a third cavity are accommodated in the headphone shell, a first microphone is transversely installed in the first cavity, a second microphone is vertically installed in the third cavity, and the first microphone and the second microphone are connected to the control circuit through a sound signal transmission line; the sound making unit is transversely installed in the second cavity, the sound making side of the sound making unit upwardly faces toward the sound making opening of the third cavity, and the second microphone is located above the sound making unit.

### BACKGROUND OF THE INVENTION

1. Technical Field

The invention relates to the technical field of communication, especially relates to headphones, and concretely relates to in-ear headphones with the noise reduction effect.

2. Description of Related Art

Common headphones are mainly composed of four parts: headbands, sound making units, earmuffs and leads; the headbands are used for fixing the earmuffs to ears, the leads are used for transmitting sound signals from sound boxes to sound making units, and the sound making units are arranged in the earmuffs. Generally, current headphones have the noise reduction function, and a microphone for acquiring sound samples is respectively arranged outside left and right earmuffs; with diversified and changeable external noise, only one earmuff can accommodate a full-noise sampling microphone so that noise sampling directions are narrow and inexact and the high-quality noise reduction effect cannot be achieved.

In order to solve the disadvantages of the headphones, a double-microphone noise reduction scheme has been adopted on the current market, namely two microphones are arranged at different positions of terminals and used for acquiring sound samples, after sound signals acquired by two microphones are compared, signals from noise signal frequency bands are attenuated to achieve the noise reduction purpose. Generally, the double-microphone headphones on the current market are either external-mounting headphones or head-wearing headphones. Due to restriction of the double-microphone installation structure, the in-ear headphones adopting the double-microphone noise reduction scheme are not researched and developed. Besides, users feel uncomfortable at 250 Hz and 60 db, only the disadvantage of low-frequency noise can be reduced through the traditional active noise reduction technology; because the traditional technology has the smaller noise reduction depth and width, the total noise reduction ability is low.

### BRIEF SUMMARY OF THE INVENTION

The invention aims to solve the disadvantages and disclose the in-ear headphones with the noise reduction effect. The in-ear headphones adopt the double-microphone structure to reduce noise and achieve the better noise reduction effect, and thus the in-ear headphones are more applicable to various high-noise environments.

The purpose of the invention is realized by the following way:

The in-ear headphones with the noise reduction effect comprise the headphone shell in which the sound making unit and the control circuit are installed. The control circuit and the sound making unit are interconnected, and the sound making unit is connected with the sound signal transmission line; the first cavity, the second cavity and the third cavity are accommodated in the headphone shell, the first cavity is located on the bottom of the headphone shell, the first microphone is transversely installed in the first cavity and the sound receiving side of the first microphone is either upwards or downwards.

The third cavity is located on the top of the headphone shell, the air outlet pipeline forms in the third cavity, the top of the third cavity is used as the sound spreading opening for spreading sound, the earmuff capable of inserting the human body ear canal is sleeved outside the sound spreading opening, the second microphone is vertically installed in the third cavity and the sound receiving side of the second microphone is either the left or the right, and the central vertical line of the second microphone is perpendicular to the inner wall of the air outlet pipeline. The first microphone and the second microphone are connected to the control circuit through the sound signal transmission line, the second cavity is located between the first cavity and the third cavity, the sound making unit is transversely installed in the second cavity, the sound making side of the sound making unit upwardly faces toward the sound making opening of the third cavity, and the second microphone is located above the sound making unit.

In the above description, as the optimized scheme, the control circuit comprises the first detection unit, the second detection unit, the comparison unit, the calculation unit and the sound wave output unit.

Noise frequency signals acquired by the first microphone are named as sound frequency 1, and noise frequency signals acquired by the second microphone are named as sound frequency 2. The sound frequency 1 and the sound frequency 2 are respectively input to the control circuit, and waveform data of noise sound waves occurred by mixing sound waves of the sound frequency 1 and the sound frequency 2 are received and calculated by the control circuit and transmitted to the sound making unit. According to data provided by the control circuit, the sound making unit generates sound waves to automatically neutralize noise, and herein the sound waves and the noise sound waves have the same amplitude and opposite phase. In this way, the sounds given by the sound making unit can avoid interference of environmental noise at the greatest extent so that people can listen in relatively quiet environment and hear clear and graceful sounds.

In the above description, as the optimized scheme, the first microphone and the second microphone respectively acquire noise frequency signals from opposite directions.

In the above description, as the optimized scheme, the second microphone is located on the central vertical line of the sound making side of the sound making unit.

As the preferred scheme, the sound making unit is the high-fidelity loudspeaker.

In the above description, as the optimized scheme, the first clamp for accommodating the first microphone is arranged in the first cavity and the detachable baseboard is arranged on the bottom of the first cavity.

As the preferred scheme, the second clamp for accommodating the second microphone is arranged in the third cavity and the arc protection cap with a plurality of through holes is permanently installed above the second clamp.

Compared with the current technology, the double-microphone sampling way is adopted and the installation positions of microphones are also defined in the in-ear headphones, the second microphone is permanently and transversely installed on the central vertical line of the sound making side of the sound making unit, after testing, the structure has the widest noise reduction range and the most comprehensive effect. The noise is reduced by the dual way so that the noise sampling sensitivity and accuracy can be effectively improved and the environmental noise in the headphone shell can be also effectively reduced; the microphones in the headphone shell respectively acquire sound waves from the opposite directions to achieve one better sound sample acquisition effect, sound waves which are opposite to real noise in directions and have the same amplitude as the real noise are generated by the control circuit and the sound making unit to perform automotive resistance and achieve the better noise reduction effect. Besides, the second microphone can more fully and precisely acquire various sound waves from the sound making unit and the outside so that users can better enjoy music entertainment and solve various noise-related troubles in the daily life (such as noise from airports, industry and subways), just like, users suddenly change from noisy environment to very quiet environment.

The in-ear headphones with the noise reduction effect have the following beneficial effects:

(1) The double-microphone structure is suitable for the in-ear headphones and different from the traditional external-mounting double-microphone headphone structure, the second microphone is permanently and transversely installed on the central vertical line of the sound making side of the sound making unit, after strict and accurate testing, the special installation structure has the best noise reduction effect and the strong environmental suitability and still keeps the remarkable noise reduction effect under the environment (for example airports and subways) with particularly harsh noise;

(2) According to the measured data of the noise reduction curve graph, whether noise reduction depth (maximum noise reduction ability) or noise reduction width (noise reduction frequency range), the in-ear headphones are far more than the current mainstream headphones adopting the active noise reduction technology, and the total noise reduction ability (noise reduction area) is more than 2 times of that involved in the current mainstream technology;

(3) Compared with the traditional active noise reduction technology, the in-ear headphones not only can reduce the low-frequency noise and but also can sharply reduce the real life noise (for example fan, air conditioner and talking in subways).

### BRIEF DESCRIPTION OF THE SEVERAL VIEWS OF THE DRAWINGS

FIG. 1 is X-direction sectional drawing of in-ear headphones in accordance with an embodiment of the invention;

FIG. 2 is Y-direction sectional drawing of in-ear headphones in accordance with an embodiment of the invention;

FIG. 3 is noise reduction curve graph of first microphone in accordance with an embodiment of the invention;

FIG. 4 is noise reduction curve graph of second microphone in accordance with an embodiment of the invention;

FIG. 5 is constitutional diagram of FIG. 3 and FIG. 4;

In Figure, headphone shell 1, high-fidelity loudspeaker 2, first cavity 3, second cavity 4, third cavity 5, first microphone 6, second microphone 7, sound signal transmission line 8, second clamp 9, and arc protection cap 10.

### DETAILED DESCRIPTION OF THE INVENTION

The in-ear headphones are further elaborated according to Figures and specific embodiment.

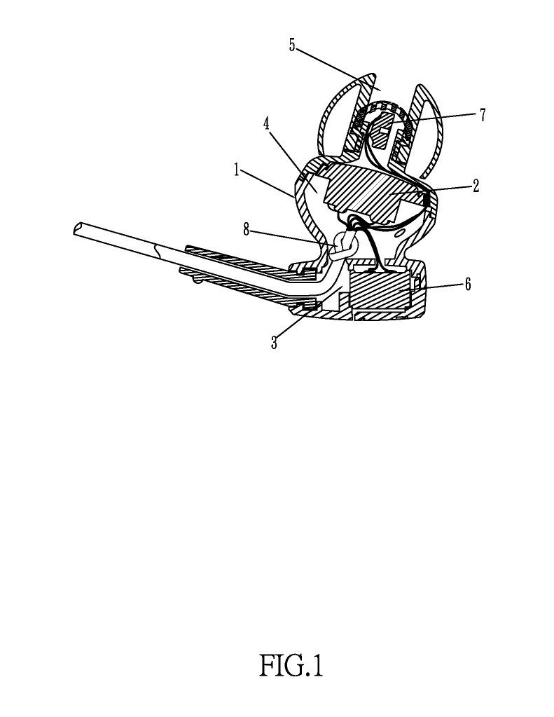

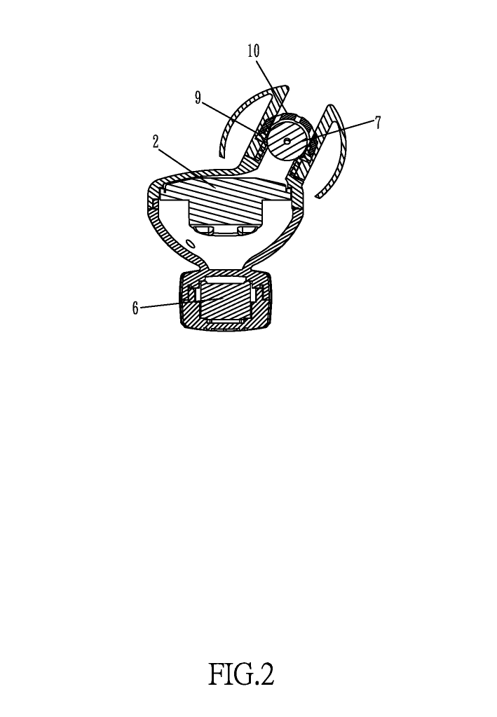

In the embodiment, please refer to FIG. 1 and FIG. 2, the in-ear headphones comprise the headphone shell 1 in which the sound making unit and the control circuit are installed, and the sound making unit of the embodiment is the high-fidelity loudspeaker 2. The control circuit and the sound making unit are interconnected, and the sound making unit is connected with the sound signal transmission line 8. The control circuit comprises the first detection unit, the second detection unit, the comparison unit, the calculation unit and the sound wave output unit.

The first cavity 3, the second cavity 4 and the third cavity 5 are accommodated in the headphone shell 1, the first cavity 3 is located on the bottom of the headphone shell 1, the first microphone 6 is transversely installed in the first cavity 3 and the sound receiving side of the first microphone 6 is either upwards or downwards. The third cavity 5 is located on the top of the headphone shell 1, the air outlet pipeline forms in the third cavity 5, the top of the third cavity 5 is used as the sound spreading opening for spreading sound, and the earmuff capable of inserting the human body ear canal is sleeved outside the sound spreading opening. The second microphone 7 is vertically installed in the third cavity 5 and the sound receiving side of the second microphone 7 is either the left or the right, and the central vertical line of the second microphone 7 is perpendicular to the inner wall of the air outlet pipeline.

The first clamp for accommodating the first microphone 6 is arranged in the first cavity 3 and the detachable baseboard is arranged on the bottom of the first cavity 3. The second clamp 9 for accommodating the second microphone 7 is arranged in the third cavity 5 and the arc protection cap 10 with a plurality of through holes is permanently installed above the second clamp 9 and located below the sound spreading opening.

The first microphone 6 and the second microphone 7 are connected to the control circuit through the sound signal transmission line 8, the second cavity 4 is located between the first cavity 3 and the third cavity 5, the first microphone 6 and the second microphone 7 respectively acquire noise frequency signals from the opposite directions, the sound making unit is transversely installed in the second cavity 4, the sound making side of the sound making unit upwardly faces toward the sound making opening of the third cavity 5, and the second microphone 7 is located on the central vertical line of the sound making side of the sound making unit.

In the embodiment, the in-ear headphones with the noise reduction effect has the principle of noise reduction as follows: firstly, environmental low-frequency noise (100-500 HZ) heard by ears is detected by the first microphone 6 and the second microphone 7 respectively installed in the headphone shell 1, noise signals are transmitted to the control circuit and immediately calculated by the control circuit, sound waves which are opposite to the noise in directions and have the same amplitude as the noise are emitted by the high-fidelity loudspeaker to neutralize the noise, so that the low-frequency noise transmitted in the ears can be sharply reduced and the audio environment is quieter.

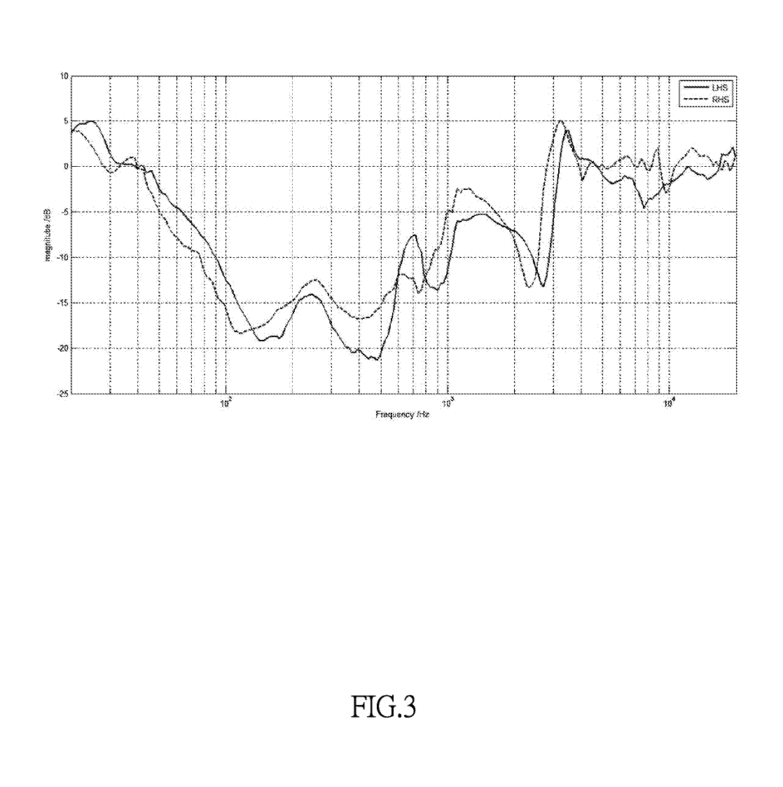

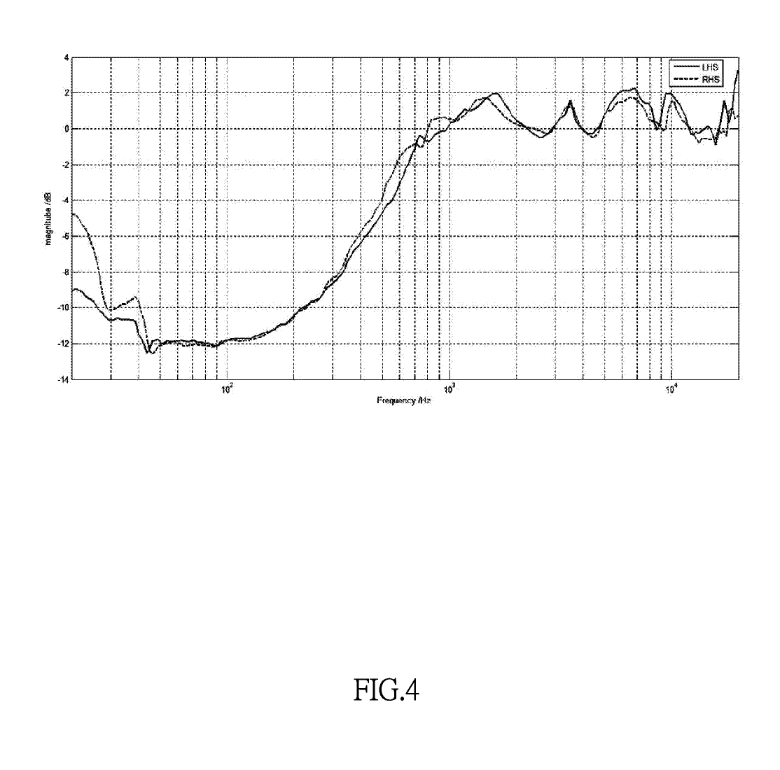

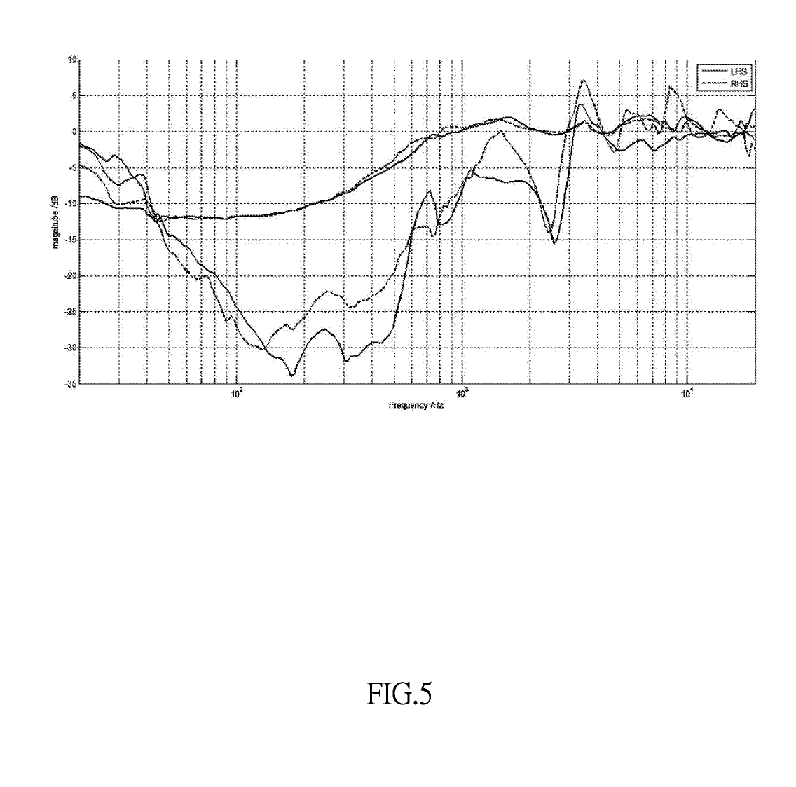

Noise reduction curve graphs are as shown in FIG. 3-FIG. 5, the horizontal axis in Figure is sound frequency (Hz) and the longitudinal axis is noise reduction scope (dB). Any point on the axis indicates the noise reduction scope on the corresponding sound frequency. According to the measured noise reduction curve graph as shown in FIG. 5, by adopting the structure of the embodiment, the maximum noise reduction depth reaches 34 db, whether noise reduction depth (maximum noise reduction ability) or noise reduction width (noise reduction frequency range), the in-ear headphones are far more than the current mainstream headphones adopting the active noise reduction technology, and the total noise reduction ability (noise reduction area) is more than 2 times of that involved in the current mainstream technology. Thus wearers can experience a particularly quiet ear world and can be brought in the quiet world by the headphones to prevent noise harm and enjoy the top-level pleasure whether the wearers are in obstreperous paths or sitting quietly in offices and families.

Besides, in the structure of the embodiment, the second microphone 7 is permanently and transversely installed on the central vertical line of the sound making side of the sound making unit, the structure only directs at the in-ear headphones, after testing, the structure has the widest noise reduction range, the most comprehensive effect and the strong environmental suitability and still keeps the remarkable noise reduction effect under the environment (for example airports and subways) with particularly harsh noise, namely the structure is corresponding to the noise reduction curve graph as shown in FIG. 5. Compared with the traditional active noise reduction technology, the in-ear headphones not only can reduce the low-frequency noise and but also can sharply reduce the real life noise (for example fan, air conditioner and talking in subways).

The above contents are used for further elaborating the in-ear headphones according to the specific preferred embodiment, but the specific embodiment cannot be affirmed to be restricted to the description. Ordinary technical personnel versed in the technical field of the headphones can carry out simple derivation or substitution which are deemed within the protection range of the invention when do not break away from the invention concept.

1. In-ear headphones with a noise reduction effect comprise a headphone shell, a sound making unit and a control circuit are installed in the headphone shell and interconnected, and the sound making unit is connected with a sound signal transmission line; characterized in that a first cavity, a second cavity and a third cavity are accommodated in the headphone shell, the first cavity is located on the bottom of the headphone shell, a first microphone is transversely installed in the first cavity and the sound receiving side of the first microphone is either upwards or downwards; the third cavity is located on the top of the headphone shell, an air outlet pipeline forms in the third cavity, the top of the third cavity is used as a sound spreading opening for spreading sound, an earmuff capable of inserting a human body ear canal is sleeved outside the sound spreading opening, a second microphone is vertically installed in the third cavity and the sound receiving side of the second microphone is either the left or the right, and the central vertical line of the second microphone is perpendicular to the inner wall of the air outlet pipeline; the first microphone and the second microphone are connected to the control circuit through the sound signal transmission line, the second cavity is located between the first cavity and the third cavity, the sound making unit is transversely installed in the second cavity, the sound making side of the sound making unit upwardly faces toward the sound making opening of the third cavity, and the second microphone is located above the sound making unit.

2. The in-ear headphones with the noise reduction effect according to claim 1, wherein the control circuit comprises a first detection unit, a second detection unit, a comparison unit, a calculation unit and a sound wave output unit.

3. The in-ear headphones with the noise reduction effect according to claim 1, wherein the second microphone is located on the central vertical line of the sound making side of the sound making unit.

4. The in-ear headphones with the noise reduction effect according to claim 1, wherein the first microphone and the second microphone respectively acquire noise frequency signals from opposite directions.

5. The in-ear headphones with the noise reduction effect according to claim 1, wherein the sound making unit is a high-fidelity loudspeaker.

6. The in-ear headphones with the noise reduction effect according to claim 1, wherein a first clamp for accommodating the first microphone is arranged in the first cavity and a detachable baseboard is arranged on the bottom of the first cavity.

7. The in-ear headphones with the noise reduction effect according to claim 1, wherein a second clamp for accommodating the second microphone is arranged in the third cavity and an arc protection cap with a plurality of through holes is permanently installed above the second clamp.
